(19) United States
(12) Patent Application Publication
(10) Pub. No.: US 2026/0202778 A1
(43) Pub. Date: Jul. 16, 2026

(54) DISCHARGE METHOD, DEVELOPMENT DEVICE, AND IMAGE FORMING APPARATUS

(71) Applicant: FUJIFILM Business Innovation Corp., Tokyo (JP)

(72) Inventors: Kiyoshi SAKO, Kanagawa (JP); Takafumi Wakai, Kanagawa (JP)

(73) Assignee: FUJIFILM Business Innovation Corp., Tokyo (JP)

(21) Appl. No.: 19/310,602

(22) Filed: Aug. 26, 2025

(30) Foreign Application Priority Data
Jan. 15, 2025 (JP) 2025-005621

(51) Int. Cl. G03G 15/09; G03G 21/16

(52) U.S. Cl. CPC G03G 15/0921; G03G 21/1676; G03G 2221/1654

(57) ABSTRACT

A discharge method for discharging a developer containing toner from a housing of a development device is provided, the development device including the housing that accommodates the developer, a transporting member that transports the developer in the housing, and a development member that includes a receiving pole and a release pole, that receives the developer from the transporting member at the receiving pole with a magnetic force and develops a latent image on a photoconductor with the developer, and that releases a surplus developer into the housing at the release pole, the discharge method including changing, while the development device is removed from an image forming apparatus body, a position of the development member with respect to the housing to a release position to direct the release pole toward an outside of the housing, and changing a position of the housing to direct the release pole downward while the development member is in the release position, and driving the transporting member to discharge the developer from the housing.

### CROSS-REFERENCE TO RELATED APPLICATIONS

This application is based on and claims priority under 35 USC 119 from Japanese Patent Application No. 2025-005621 filed Jan. 15, 2025.

### BACKGROUND

### (i) Technical Field

The present disclosure relates to a discharge method, a development device, and an image forming apparatus.

### (ii) Related Art

Japanese Unexamined Patent Application Publication No. 2007-316456 describes a development device. The development device includes a housing that stores a magnetic developer, a developer supporter at which a magnetic field generator having multiple magnetic poles inside is rotatably disposed and that holds a developer fed from the housing, a pole fixing member that is fixed at one end of a support shaft of the magnetic field generator to restrict rotation of the magnetic field generator, and a magnetic or nonmagnetic restrictor disposed to face the developer supporter to restrict the amount of the developer on the developer supporter. At the end surface of the support shaft, a fixing groove is formed. The pole fixing member includes a protruding press-fitted portion at least part of which is press-fitted into the fixing groove.

### SUMMARY

Aspects of non-limiting embodiments of the present disclosure relate to a method for discharging of a developer from a housing of a development device without disassembling the housing.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a discharge method for discharging a developer containing toner from a housing of a development device, the development device including the housing that accommodates the developer, a transporting member that transports the developer in the housing, and a development member that includes a receiving pole and a release pole, that receives the developer from the transporting member at the receiving pole with a magnetic force and develops a latent image on a photoconductor with the developer, and that releases a surplus developer into the housing at the release pole, the discharge method including changing, while the development device is removed from an image forming apparatus body, a position of the development member with respect to the housing to a release position to direct the release pole toward an outside of the housing, and changing a position of the housing to direct the release pole downward while the development member is in the release position, and driving the transporting member to discharge the developer from the housing.

### BRIEF DESCRIPTION OF THE DRAWINGS

Exemplary embodiments of the present disclosure will be described in detail based on the following figures, wherein:

FIG. 1 is a schematic front view of an image forming apparatus according to a first exemplary embodiment of the present disclosure;

FIGS. 2A and 2B are views of an internal structure of a development device according to the first exemplary embodiment, where FIG. 2A is a front view of a release pole directed toward the inside of the housing, and FIG. 2B is a front view of a release pole directed toward the outside of the housing;

FIG. 3A is a left side view of a first support member according to the first exemplary embodiment, FIG. 3B is a front view of the first support member, and FIG. 3C is a front view of a second support member according to the first exemplary embodiment;

FIG. 4 is a front view of an internal structure of a development device according to the first exemplary embodiment, in a state where a development member is supported by the first support member in a first position;

FIG. 5 is a front view of a development device obtained by replacing the first support member in the development device in FIG. 4 with a second support member;

FIG. 6A is a front view of an internal structure of the development device according to the first exemplary embodiment, in a state where the development member is supported in a second position by the second support member, and FIG. 6B is a front view of the development device, in a state where a developer is discharged from the inside of the development device in FIG. 6A;

FIGS. 7A and 7B are front views of an internal structure of the development device according to a second exemplary embodiment, where FIG. 7A is a front view of the development member supported in the first position by the first support member, and FIG. 7B is a front view of the development member supported in the second position by the first support member and in the state of being unattachable to an apparatus body;

FIGS. 8A and 8B are front views of an internal structure of the development device according to the second exemplary embodiment, where FIG. 8A is a front view of the development member supported in the second position by the first support member, and FIG. 8B is a front view of the development device, in the state where a developer is discharged from the inside of the development device in FIG. 8A;

FIG. 9 is a front view of a third support member, corresponding to a first support member according to a first modification example;

FIGS. 10A and 10B are front views of an internal structure of a development device according to a first modification of the second exemplary embodiment, where FIG. 10A is a front view of the development member supported in the first position by the third support member, and FIG. 10B is a front view of the development member supported in the second position by the third support member;

FIG. 11 is a front view of the development device, in the state of being disposed at a flat workplace in a position in which the development device in FIG. 10B is capable of discharging the developer from the inside; and

FIG. 12A is a front view of a first support member according to a second modification example, and FIG. 12B is a front view of a first support member according to a third modification example.

### DETAILED DESCRIPTION

### First Exemplary Embodiment

With reference to the drawings, an image forming apparatus according to an exemplary embodiment (a first exemplary embodiment) of the present disclosure is described. In the drawings, an arrow H denotes the apparatus height direction (the vertical direction), an arrow W denotes the apparatus width direction (the horizontal direction), and an arrow D denotes the apparatus depth direction (the horizontal direction).

### Entire Structure of Image Forming Apparatus

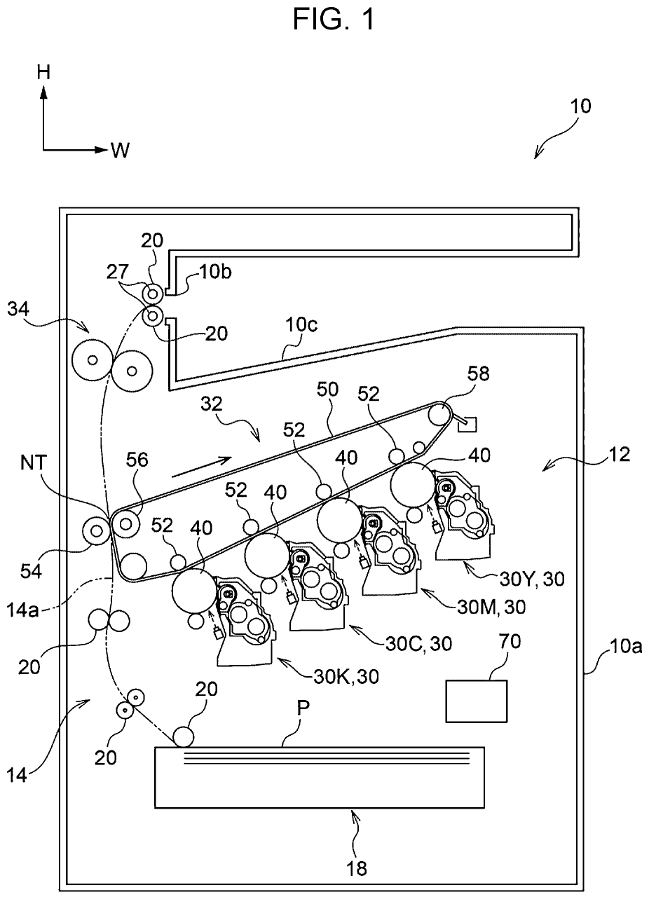

As illustrated in FIG. 1, an image forming apparatus 10 forms images on sheet members P. The sheet members P are examples of media. The image forming apparatus 10 accommodates components in a box-shaped apparatus body 10a. The apparatus body 10a is an example of an image forming apparatus body. The image forming apparatus 10 includes a container 18, a transport portion 14, and an image forming portion 12. The image forming apparatus 10 further includes a fixing portion 34, and a controller 70. The apparatus body 10a includes an opening portion 10b and a tray 10c. The opening portion 10b is an opening extending in the depth direction, and from which the sheet member P on which an image is formed is discharged from the inside of the apparatus body 10a. The tray 10c is a part of the apparatus body 10a having a flat surface that receives the sheet member P discharged from the opening portion 10b.

### Container

The container 18 has a box shape with an upper portion open, and is disposed at a lower portion in the apparatus body 10a. The container 18 accommodates a stack of multiple sheet members P.

### Transport Portion

The transport portion 14 transports the sheet members P to the components in the apparatus body 10a. In the present exemplary embodiment, the transport portion 14 transports the sheet members P with multiple rollers 20 including a pair of discharging rollers 27 along a transport path 14a extending in the vertical direction and the width direction in the apparatus body 10a.

### Image Forming Portion 12

The image forming portion 12 forms toner images on the sheet members P through an electrophotographic system. The toner images are examples of images. The image forming portion 12 is disposed above the container 18. As illustrated in FIG. 1, the image forming portion 12 includes toner image forming portions 30, and a transfer portion 32.

The multiple toner image forming portions 30 each form toner images of a different color. In the present exemplary embodiment, the toner image forming portions 30 include toner image forming portions 30Y, 30M, 30C, and 30K for four colors of yellow (Y), magenta (M), cyan (C), and black (K).

In the following description, Y, M, C, and K appended to the reference signs are omitted when the colors of yellow (Y), magenta (M), cyan (C), and black (K) are not to be distinguished from each other.

The toner image forming portions 30 for the respective colors have basically the same structure except for using toner of different colors. Each toner image forming portion 30 performs processes of charging, exposure, and development for a different color. More specifically, each of the toner image forming portions 30 performs processes of charging, with electricity, a latent image on a photoconductor 40 for the corresponding color of toner accommodated in the apparatus body 10a, exposing the latent image to light, and developing the latent image with a development device 80, described below.

The transfer portion 32 transfers the toner images formed by the toner image forming portions 30 on a sheet member P. The transfer portion 32 is an example of a transfer device that transfers a latent image to a medium. As illustrated in FIG. 1, the transfer portion 32 includes a transfer belt 50, first transfer rollers 52, and a winding roller 56. The transfer portion 32 further includes a driving roller 58 and a second transfer roller 54.

The transfer belt 50 is a belt extending in the depth direction and endless in the width direction and the vertical direction. Toner images of respective colors are first-transferred in a superposed manner by the toner image forming portions 30 to the transfer belt 50.

The first transfer rollers 52 are cylinders extending in the depth direction. The first transfer rollers 52 are disposed to face the toner image forming portions 30 with the transfer belt 50 interposed therebetween. The first transfer rollers 52 transfer the toner images formed by the toner image forming portions 30 to the transfer belt 50. In the present exemplary embodiment, four first transfer rollers 52 corresponding to the colors of toner are provided.

The winding roller 56 is a cylinder extending in the depth direction. The transfer belt 50 is wound around the outer circumference of the winding roller 56.

The driving roller 58 is a cylinder extending in the depth direction, and driven by a driving portion (not illustrated) to rotate about the depth direction. The driving roller 58 around which the transfer belt 50 is wound transmits a rotational force to the transfer belt 50. Thus, the transfer belt 50 rotates in the arrow direction in the drawing.

The second transfer roller 54 is disposed to face the winding roller 56 with the transfer belt 50 interposed therebetween and transfers toner images transferred to the transfer belt 50 to the sheet members P. Between the second transfer roller 54 and the transfer belt 50, a transfer nip NT that transfers the toner images to the sheet members P is formed. The second transfer roller 54 is disposed downstream in the transport direction of the pair of rollers 20. More specifically, in conjunction with a transfer (second transfer) at a transfer nip NT, the pair of rollers 20 transport the sheet member P.

In this structure, in order of yellow (Y), magenta (M), cyan (C), and black (K), toner images are first-transferred to the transfer belt 50 by the first transfer rollers 52. In addition, the second transfer roller 54 transfers the toner images from the transfer belt 50 to the sheet members P transported while being held between the transfer belt 50 and the second transfer roller 54.

### Fixing Portion

As illustrated in FIG. 1, the fixing portion 34 is formed from a pair of cylinders extending in the depth direction, and is disposed downstream from the transfer nip NT in the transport direction of the sheet members P. The fixing portion 34 heats and presses the toner images transferred to the sheet members P to fix the toner images to the sheet members P. The sheet members P to which the toner images are fixed are discharged by the pair of discharging rollers 27 through the opening portion 10b to the tray 10c.

The image forming apparatus 10 thus forms images on the sheet members P.

### Details of Development Device

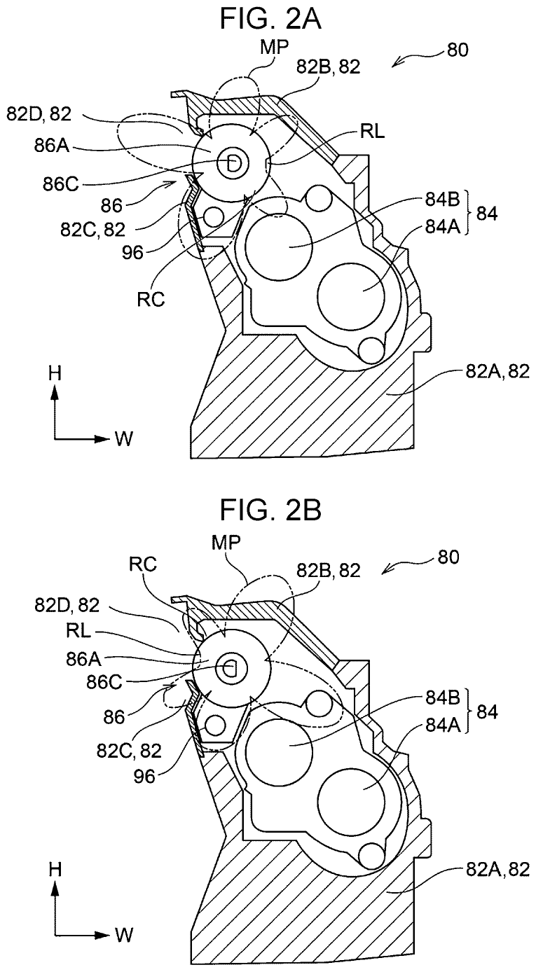

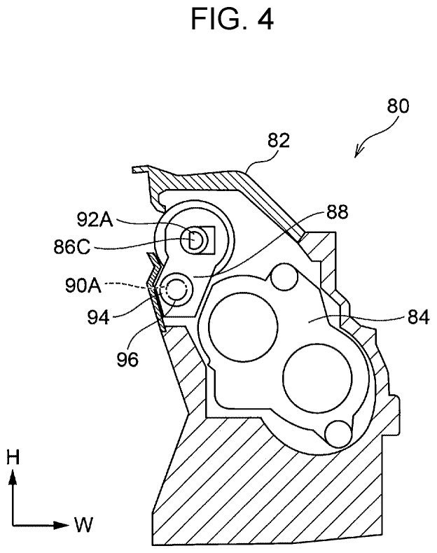

The development device 80 is described now in detail. The development device 80 is removable from and attachable to the apparatus body 10a. When attached to the image forming apparatus 10, the development device 80 develops a latent image on the photoconductor 40. As illustrated in FIG. 2A and FIG. 4, the development device 80 includes a housing 82, transporting members 84, a development member 86, and a first support member 88.

### Housing

The housing 82 is a container extending in the depth direction, and formed from multiple components. The housing 82 accommodates a developer containing negatively charged toner and a carrier formed from a magnetic body. The housing 82 further accommodates the transporting members 84 and the development member 86. The housing 82 exposes a part of the development member 86 to the outside through an opening 82D. The opening 82D is open toward one side in the width direction to allow the development member 86 to face the photoconductor 40.

The housing 82 is divisible. In the present exemplary embodiment, the housing 82 includes a body 82A, a cover 82B, and a side cover 82C.

The body 82A forms a lower portion of the development device 80. The body 82A defines a space capable of accommodating the developer and the transporting members 84.

The cover 82B is a curved portion disposed above the body 82A. While having a base end fitted to the body 82A with a fitting portion (not illustrated), the cover 82B forms an upper portion of the development device 80. A distal end of the cover 82B forms an upper outer edge of the opening 82D.

The side cover 82C is disposed below the cover 82B. The side cover 82C is a plate-shaped member extending in the depth direction. While having a base end (lower end) fitted to the body 82A with a fitting portion (not illustrated), the side cover 82C forms an intermediate portion of the development device 80. The distal end of the side cover 82C forms a lower outer edge of the opening 82D. More specifically, the housing 82 has the opening 82D having the outer edges defined by the cover 82B and the side cover 82C. The housing 82 allows the developer to be discharged from the inside to the outside through the opening 82D.

### Transporting Members

The transporting members 84 are disposed in the housing 82 to transport the developer. More specifically, the transporting members 84 include an agitation auger 84A and a feeding auger 84B. In the transporting members 84, the feeding auger 84B is disposed obliquely above the agitation auger 84A. The agitation auger 84A is driven by a driving portion (not illustrated) to rotate about the depth direction. The agitation auger 84A agitates the developer. The feeding auger 84B feeds the developer to the development member 86. More specifically, the developer is circularly transported in the housing 82 with the operations of the agitation auger 84A and the feeding auger 84B, and a part of the developer is fed to a receiving pole RC, described later, of the development member 86. More specifically, the developer is transported to the feeding auger 84B with the rotation of the agitation auger 84A, and a part of the developer is fed to the receiving pole RC of the development member 86 with the rotation of the feeding auger 84B.

### Development Member

The development member 86 has a roller shape extending in the depth direction. The development member 86 is disposed obliquely above the transporting members 84 in the housing 82, while having a portion exposed through the opening 82D between the cover 82B and the side cover 82C. The development member 86 is disposed to face the photoconductor 40. A negative development bias voltage is applicable from a power source portion (not illustrated) to the development member 86. The development member 86 includes a sleeve (not illustrated) and a magnet roller 86A.

The sleeve is a cylinder disposed around the outer circumferential surface of the magnet roller 86A. The sleeve is driven by a driving portion (not illustrated) to rotate clockwise about the depth direction.

The magnet roller 86A is a solid cylinder inserted into the sleeve. The magnet roller 86A is supported to be unrotatable relative to the housing 82. Around the outer circumferential surface of the magnet roller 86A, the sleeve rotates relative to the magnet roller 86A. The magnet roller 86A includes multiple permanent magnets (not illustrated), and a shaft 86C.

The multiple permanent magnets are disposed inside the magnet roller 86A. In the present exemplary embodiment, five permanent magnets are disposed in the magnet roller 86A. The permanent magnets each have the S-poles or the N-poles on the surface along the circumferential direction of the sleeve. The permanent magnets form a magnetic profile MP indicated by a two-dot chain line. In the present exemplary embodiment, the permanent magnets sequentially having the S-pole, the N-pole, the S-pole, the N-pole, and the S-pole are arranged clockwise from the position closest to the feeding auger 84B. In other words, the permanent magnets form at least a receiving pole RC and a release pole RL inside the magnet roller 86A. In the present exemplary embodiment, each release pole RL is formed in an area between a permanent magnet (S-pole) adjacent counterclockwise to a permanent magnet (S-pole) serving as the receiving pole RC.

The receiving pole RC is an area that receives, with the magnetic force, the developer fed from the feeding auger 84B in the transporting members 84. The receiving pole RC is a surface area of the sleeve corresponding to the permanent magnet (S-pole) positioned closest to the feeding auger 84B. The developer received by the receiving pole RC from the feeding auger 84B is transported to the sleeve surface facing the photoconductor 40 with the rotation of the sleeve clockwise about the depth direction.

The release pole RL is an area where the line of magnetic force in the magnetic profile MP is exerted in the opposite direction to the receiving pole RC. The release pole RL releases the developer. More specifically, the release pole RL releases, into the housing 82, the developer received by a portion of the sleeve disposed around the outer circumference of the receiving pole RC and left without being used for development of the latent image on the photoconductor 40. The developer not used for development of the latent image on the photoconductor 40 is an example of a surplus developer.

The shaft 86C is a rod-shaped member extending in the depth direction and having a front end in the depth direction with a shape of the letter “D” when viewed from the front. The shaft 86C is supported on the housing 82 with the first support member 88. The details are described later. When the shaft 86C is supported on the housing 82, the position of the magnet roller 86A with respect to the housing 82 is uniquely determined. For example, when the shaft 86C is supported on the housing 82 while the release pole RL is directed in the direction illustrated in FIG. 2A, the release pole RL is capable of releasing the developer into the housing 82. The position where the position of the development member 86 is retained while the release pole RL is directed toward the inside of the housing 82 is referred to as a first position Q1.

### First Support Member

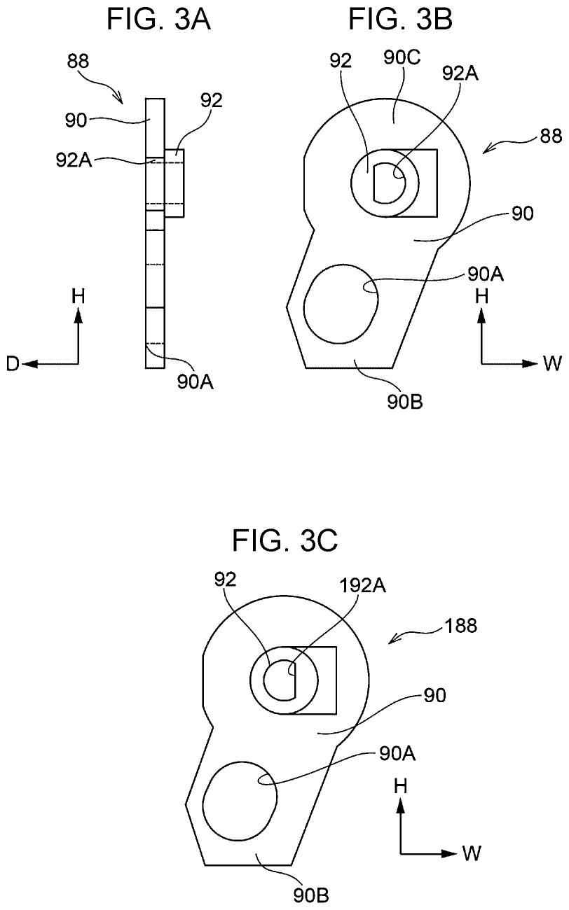

As illustrated in FIG. 3A and FIG. 3B, the first support member 88 is a plate-shaped member including a boss. The first support member 88 allows the development member 86 to be supported on the housing 82. In the present exemplary embodiment, the first support member 88 supports the shaft 86C in a predetermined position with respect to the housing 82. The first support member 88 includes a plate 90 and a boss 92.

The plate 90 is a plate extending in the vertical direction. More specifically, when viewed from the front, a lower portion of the plate 90 has a polygonal shape, and an upper portion of the plate 90 has an arc shape. The polygonal-shaped portion of the plate 90 corresponds to an end portion 90B. The arc-shaped portion of the plate 90 corresponds to an arc portion 90C. The end portion 90B has an attachment hole 90A. In the present exemplary embodiment, the attachment hole 90A is a long hole. The attachment hole 90A is formed in the plate 90 while having the longitudinal direction of the long hole extending obliquely to the vertical direction.

The boss 92 is a protruding portion disposed to overlap the arc portion 90C of the plate 90 in the plate thickness direction of the plate 90. The boss 92 includes an attachment hole 92A. The attachment hole 92A is a through-hole that extends through the plate 90 in the plate thickness direction. The attachment hole 92A has a letter “D” shape. Of the attachment hole 92A according to the present exemplary embodiment, the straight portion of the letter “D” extends in the vertical direction. Of the attachment hole 92A in the present exemplary embodiment, the arc-shaped portion of the letter “D” is disposed on one side in the width direction. The attachment hole 92A in the present exemplary embodiment is positioned on an extension line of the attachment hole 90A of the plate 90 in the longitudinal direction. The opening area of the attachment hole 92A is smaller than the opening area of the attachment hole 90A. The attachment hole 92A is attachable to the front end portion of the shaft 86C in the depth direction.

As illustrated in FIG. 4, the attachment hole 92A in the first support member 88 is attached to the shaft 86C to be fitted to the front end portion of the shaft 86C in the depth direction. In the first position Q1, the first support member 88 is supported on the development device 80 while having a bolt 94 fastened to a bolt hole 96 in the development device 80 through the attachment hole 90A.

In this manner, the first support member 88 retains the position of the development member 86 while directing the release pole RL toward the inside of the housing 82. The development member 86 having the position retained in the above position is capable of developing the latent image on the photoconductor 40.

### Related Portion of Development Device

Now, the structure of the development device 80 in which a developer is discharged from the inside of the housing 82 is described. As illustrated in FIG. 2B, in the state of being removed from the apparatus body 10a, the development device 80 is capable of discharging the developer. When the shaft 86C of the development member 86 is supported on the housing 82 while being in the position illustrated in FIG. 2B, the release pole RL is capable of releasing the developer toward the outside of the housing 82. The position of the development member 86 in which the release pole RL is directed toward the outside of the housing 82 is defined as a release position RA. The position where the position of the development member 86 is retained while the release pole RL is in the release position RA is defined as a second position Q2.

In the development device 80 according to the present exemplary embodiment, the first support member 88 is replaceable with a second support member 188. The second support member 188 is described below.

### Second Support Member

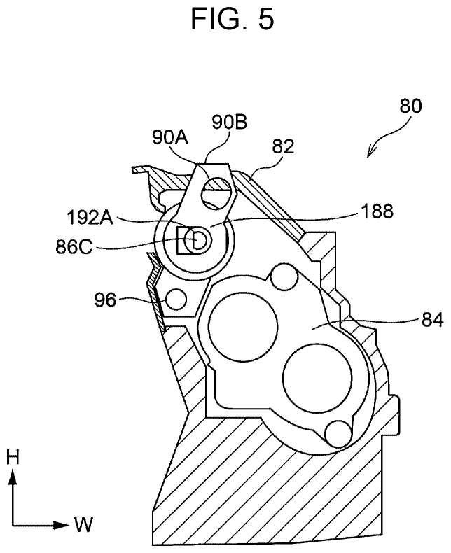

As illustrated in FIG. 3C, the second support member 188 is a plate-shaped member including a boss. The second support member 188 has the same basic structure as the first support member 88. The second support member 188 has an attachment hole 192A directed in a different direction compared to the attachment hole 92A in the first support member 88. The second support member 188 is an example of another support member. More specifically, in the second support member 188, the attachment hole 192A formed in the boss 92 has an arc-shaped portion of the letter “D” disposed on the other side in the width direction. More specifically, the second support member 188 allows the development member 86 to be supported on the housing 82 while the development member 86 is directed in a different direction from when the first support member 88 allows the development member 86 to be supported on the housing 82. The second support member 188 and the first support member 88 are not usable at the same time. In the present exemplary embodiment, as illustrated in FIG. 5, when the first support member 88 is replaced with the second support member 188 in the development device 80 in the first position, the end portion 90B of the second support member 188 is positioned above the shaft 86C.

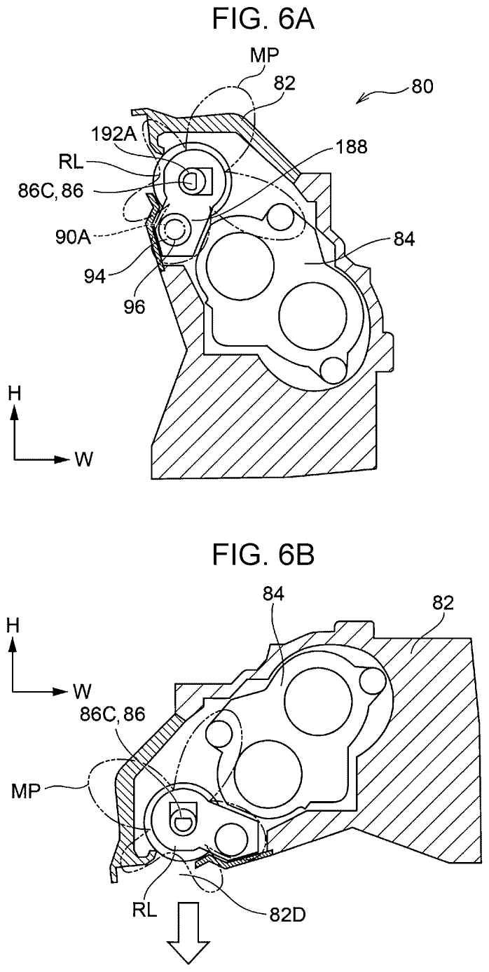

As illustrated in FIG. 6A, the second support member 188 is supported on the development device 80 while having the bolt 94 fastened to the bolt hole 96 in the development device 80 through the attachment hole 90A in the second position Q2.

In the above manner, the first support member 88 and the second support member 188 enable switching between the first position Q1 and the second position Q2.

As illustrated in FIG. 6B, in the state where the development device 80 is removed from the apparatus body 10a and the development member 86 is in the second position Q2, the opening 82D in the housing 82 is directed downward. When the agitation auger 84A is driven by an operator (not illustrated), the circulating developer is sequentially fed to the development member 86 by gravity to be released from the release pole RL. The developer is discharged from the housing 82 with this operation flow.

### Discharge Method

A method for discharging a developer from the development device 80 according to the first exemplary embodiment (discharge method) is described now.

As illustrated in FIG. 2A, the development device 80 is removed from the apparatus body 10a.

As illustrated in FIG. 2B, in the state where the development device 80 is removed from the apparatus body 10a, the position of the development member 86 with respect to the housing 82 is changed to the release position RA. To change the position of the development member 86 to the release position RA, the first support member 88 illustrated in FIG. 4 is replaced with the second support member 188 illustrated in FIG. 6A, and thus the position of the development member 86 is changed to the release position RA.

As illustrated in FIG. 6B, in the state where the position of the housing 82 is changed to direct the release pole RL downward while the development member 86 is in the release position RA, the transporting members 84 are driven to discharge the developer from the housing 82.

### Operations of First Exemplary Embodiment

Operations of the first exemplary embodiment are described.

A discharge method according to the first exemplary embodiment is a method for discharging a developer containing toner from a housing of the development device 80. The development device 80 includes the housing 82 that accommodates the developer, the transporting members 84 that transport the developer in the housing 82, and the development member 86 that receives the developer from the transporting members 84 at a receiving pole with a magnetic force to develop a latent image on the photoconductor 40, the development member 86 releasing a surplus developer into the housing 82 with a release pole RL. The method includes changing, in a state where the development device 80 is removed from the apparatus body 10a, the position of the development member 86 with respect to the housing 82 to a release position RA to direct the release pole RL toward the outside of the housing 82, and driving, in a state where the position of the housing 82 is changed to direct the release pole RL downward while the development member 86 is in the release position RA, the transporting members 84 to discharge the developer from the housing.

The discharge method enables the developer to be discharged from the housing 82 of the development device 80 without disassembling the housing 82.

With the discharge method according to the first exemplary embodiment, the development device 80 includes the first support member 88 that allows the development member 86 to be supported on the housing 82, and the position of the development member 86 is changed to the release position RA by replacing the first support member 88 with the second support member 188 while the release pole RL is directed toward the outside of the housing 82.

The discharge method facilitates discharging of the developer from the housing 82, compared to a structure in which the position of the development member from which the support member is removed is freely movable.

The development device 80 according to the first exemplary embodiment includes the housing 82 that accommodates a developer containing toner, the transporting members 84 that are disposed in the housing 82 to transport the developer, the development member 86 including a receiving pole that receives, with a magnetic force, the developer transported from the transporting members 84 and a release pole RL that releases the developer received by the receiving pole, the development member 86 being disposed in the housing 82, the development member 86 developing a latent image on the photoconductor 40 with the developer received by the receiving pole, and the first support member 88 and the second support member 188 attached to the development member 86, the first support member 88 and the second support member 188 switching between a first position Q1 at which the position of the development member 86 is retained while the release pole RL is directed toward the inside of the housing 82 and a second position Q2 at which the position of the development member 86 is retained while the release pole RL is directed toward the outside of the housing 82.

The development device 80 with the above structure is capable of more easily discharging the developer from the housing 82 than a development device with a structure that discharges the developer from a housing by disassembling the housing.

The image forming apparatus 10 according to the first exemplary embodiment includes the photoconductor 40, the development device 80 that develops a latent image on the photoconductor 40, and the transfer portion 32 that transfers the latent image to the sheet member P.

The image forming apparatus 10 including the development device 80 with the above structure is capable of discharging the developer from the housing 82 without disassembling the housing 82.

### Second Exemplary Embodiment

An image forming apparatus according to a second exemplary embodiment of the present disclosure (a second exemplary embodiment) is described now.

The image forming apparatus according to the second exemplary embodiment has basically the same structure as the image forming apparatus according to the first exemplary embodiment. The image forming apparatus according to the second exemplary embodiment differs from the image forming apparatus according to the first exemplary embodiment in a part of the development device. More specifically, in the first exemplary embodiment, when the development device 80 is in the release position RA, the first support member 88 supported on the development device 80 is replaced with the second support member 188, whereas in the second exemplary embodiment, the second support member 188 is not included in the development device 80.

Description and reference signs of components the same as those in the first exemplary embodiment may be omitted.

### Details of Development Device

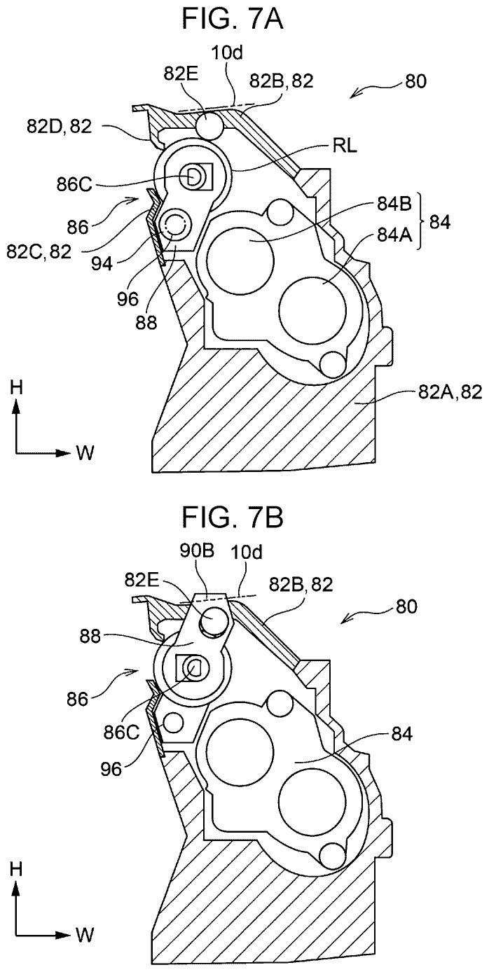

The development device 80 is described in detail. The development device 80 is removable from the apparatus body 10a, and attachable to the apparatus body 10a. As illustrated in FIG. 7A, while being attached to the apparatus body 10a, the development device 80 is disposed below a guide 10d of the apparatus body 10a. The guide 10d is a member that guides an attachment of the development device 80 to the apparatus body 10a. More specifically, the development device 80 is attachable to the apparatus body 10a without coming into contact with the guide 10d. The development device 80 includes the housing 82, the transporting members 84, the development member 86, and the first support member 88.

### Housing

The housing 82 includes the body 82A, the cover 82B, the side cover 82C, and a boss 82E.

The boss 82E is a solid cylindrical member disposed at the cover 82B and extending in the depth direction. The boss 82E is insertable into the attachment hole 90A in the first support member 88 (refer to FIGS. 3A to 3C). More specifically, the outer diameter of the boss 82E is smaller than the diameter of the attachment hole 90A.

### First Support Member

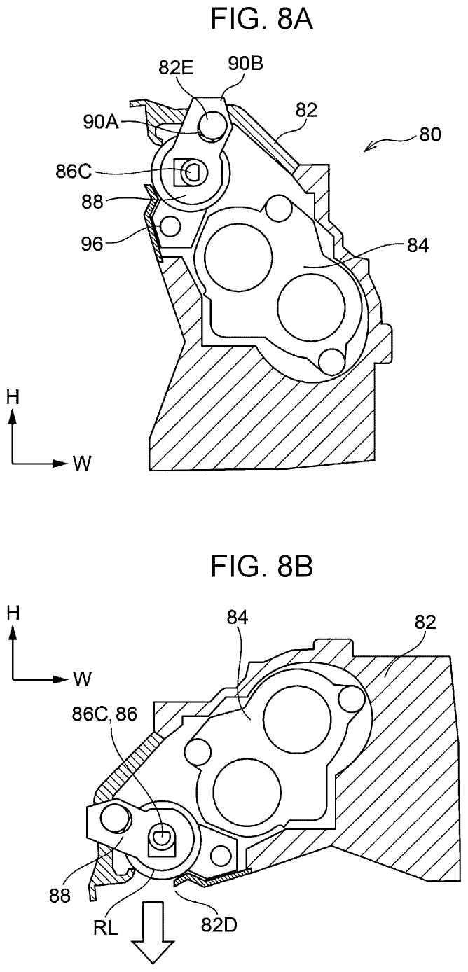

In the first position Q1, the first support member 88 is supported on the development device 80 with the bolt 94 being fastened to the bolt hole 96 in the development device 80. As illustrated in FIG. 8A, in the second position Q2, the first support member 88 is supported on the development device 80 while allowing the boss 82E to be inserted into the attachment hole 90A. In other words, the first support member 88 is switchable between the first position Q1 and the second position Q2. When the first support member 88 is in the second position Q2, the development device 80 is in the release position RA. As illustrated in FIG. 8B, while being in the release position RA, the development device 80 has the opening 82D directed downward to discharge the developer in the housing 82. The first support member 88 is an example of a switching member.

When the first support member 88 is in the second position Q2, the end portion 90B is positioned further outward from the outer edge of the housing 82. The end portion 90B is an example of a protuberance.

### Operations of Second Exemplary Embodiment

Operations of a second exemplary embodiment are described.

A discharge method according to the second exemplary embodiment is a method for discharging a developer from the development device 80 that includes the first support member 88. The first support member 88 is switchable between the first position Q1 in which the position of the development member 86 is retained while the release pole RL is directed toward the inside of the housing 82, and the second position Q2 in which the position of the development member 86 is retained while the release pole RL is directed toward the outside of the housing 82. When the position of the first support member 88 with respect to the housing 82 is switched from the first position Q1 to the second position Q2, the position of the development member 86 is changed to the release position RA.

The discharge method facilitates discharge of the developer from the housing 82 compared to a structure that switches the position by replacing support members one with the other.

In the image forming apparatus according to the second exemplary embodiment, while the first support member 88 is in the second position Q2, when the development device 80 is to be attached to the apparatus body 10a while facing the apparatus body 10a in the depth direction, the end portion 90B of the first support member 88 comes into contact with the guide 10d as illustrated in FIG. 7B. The development device 80 in the state where the end portion 90B is in contact with the guide 10d is thus not attachable to the apparatus body 10a.

More specifically, the image forming apparatus according to the second exemplary embodiment includes the apparatus body 10a, the photoconductor 40 accommodated in the apparatus body 10a, the development device 80 that is attached to the apparatus body 10a, that develops a latent image on the photoconductor 40, and that is, when attached to the apparatus body 10a while the first support member 88 is switched to the second position Q2, changed into a state of being unattachable to the apparatus body 10a as a result of the end portion 90B of the first support member 88 coming into contact with the guide 10d of the apparatus body 10a with the attachment operation, and the transfer portion 32 that transfers the latent image to a sheet member P.

In the image forming apparatus with the structure, the development device 80 in the release position RA is not erroneously attached to the apparatus body 10a.

### Modification Example

The present disclosure is described in detail based on a specific exemplary embodiment. However, it is apparent to those skilled in the art that the present disclosure is not limited to the exemplary embodiment, and may employ various other exemplary embodiments within the scope of the present disclosure.

For example, the first support member 88 according to the above exemplary embodiment may be in a modification example described below.

### First Modification Example

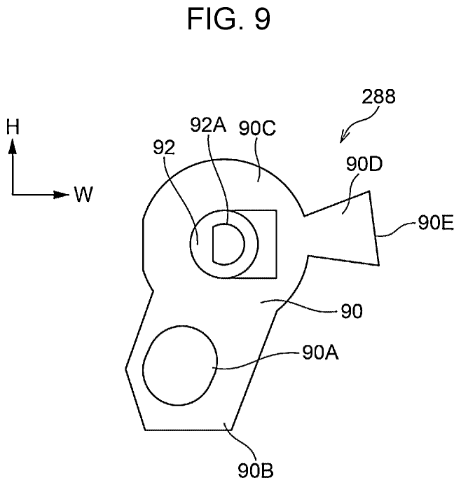

A first modification example is described. With respect to the first support member 88, a third support member 288 according to a first modification example additionally includes a protrusion at the arc portion 90C. More specifically, as illustrated in FIG. 9, the third support member 288 includes a protrusion 90D.

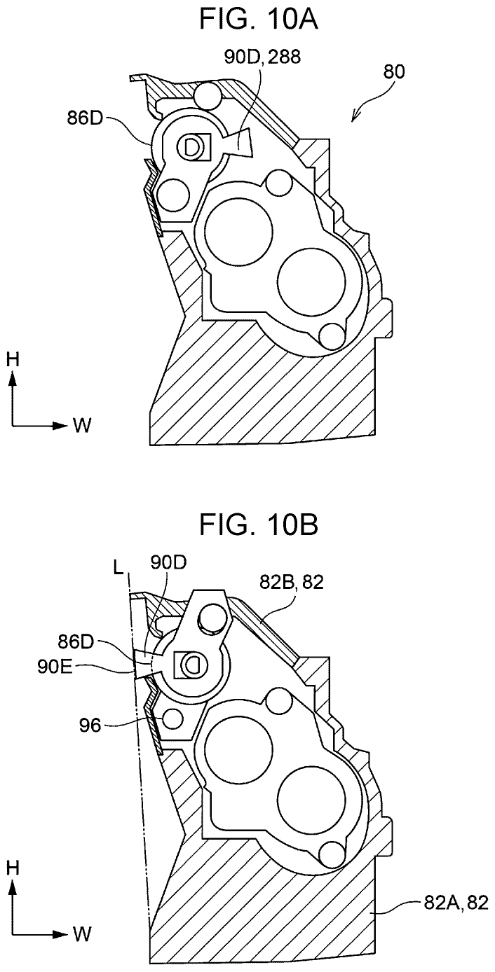

The protrusion 90D has a trapezoidal shape and protrudes from a portion of the arc portion 90C to which the arc-shaped portion of the letter “D” of the attachment hole 92A faces. As illustrated in FIGS. 10A and 10B, the protrusion 90D has an outer edge 90E positioned further outward from an outer edge 86D of the development member 86 while the third support member 288 is attached to the shaft 86C of the development device 80 in the second position Q2. The protrusion 90D is an example of a protuberance. The plate thickness of the protrusion 90D is equivalent to the plate thickness of the plate 90.

In the first modification example, in the state where the development device 80 is in the release position RA, the outer edge 90E is positioned on a virtual line L connecting the end portion of the body 82A and the end portion of the cover 82B in the housing 82. In the first modification example, the protrusion 90D gradually expands in the vertical direction as it extends from the arc portion 90C toward the outer edge 90E.

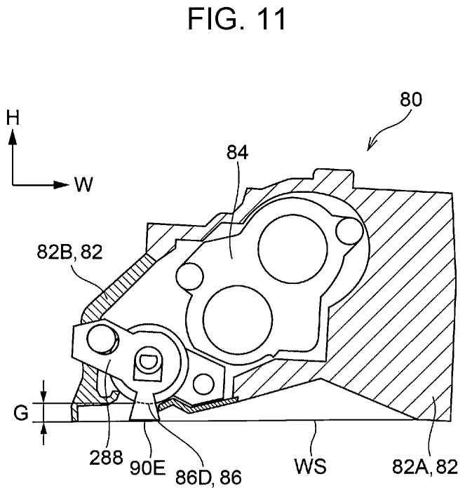

As illustrated in FIG. 11, in the first modification example, when the development device 80 is in the release position RA while the third support member 288 in the second position Q2 is attached to the shaft 86C of the development device 80, the outer edge 90E is positioned on a workplace WS, which is a box having a slit or a hole in the upper surface.

### Operations of First Modification Example

With the discharge method according to the first modification example, the developer is discharged from the housing 82 in a state where the third support member 288 is switched to the second position Q2, and the protrusion 90D extends further outward than the outer edge 86D of the development member 86 from the release pole RL.

With the discharge method, damages on the development member 86 in the release position RA are reduced further compared to a structure where the end portion of the third support member 288 is located further inward than the outer edge 86D of the development member 86 at the release pole RL in the state where the third support member 288 is switched to the second position Q2.

In the development device 80 according to the first modification example, the third support member 288 includes the protrusion 90D that extends further outward than the outer edge 86D of the development member 86 from the release pole RL while the third support member 288 is switched to the second position Q2.

In this structure, when viewed from the front, a gap G is formed between the outer edge 90E and the outer edge 86D of the development member 86. This structure reduces damages on the development member 86 caused when the developer is discharged from the housing 82 compared to a structure in which the end portion of the third support member 288 is positioned further inward than the outer edge 86D of the development member 86 at the release pole RL while the third support member 288 is switched to the second position Q2.

### Second and Third Modification Examples

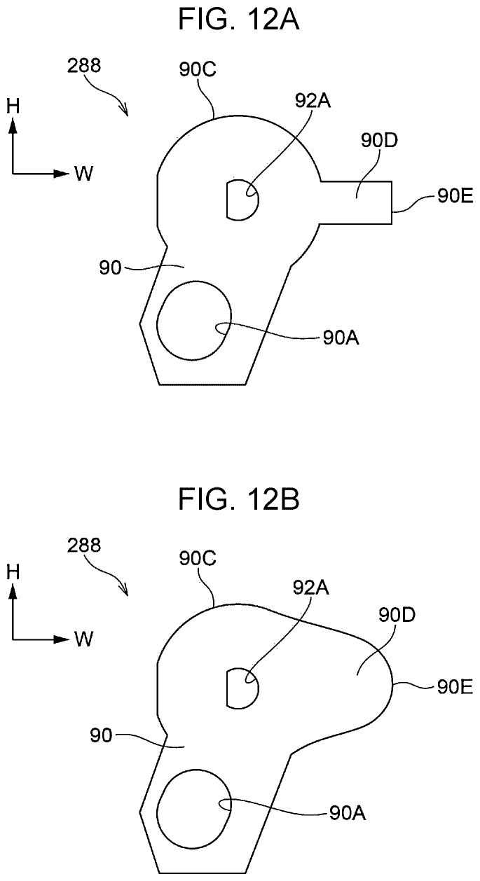

In the first modification example, the protrusion 90D of the third support member 288 has a trapezoidal shape when viewed from the front, but may have another shape. For example, as a second modification example, the protrusion 90D may have a rectangular shape when viewed from the front as illustrated in FIG. 12A. For example, as illustrated in FIG. 12B, as a third modification example, the protrusion 90D may have a rounded shape expanding from a portion of the arc portion 90C to which the arc-shaped portion of the letter “D” of the attachment hole 92A faces. The third support member 288 may have a plate shape.

### Other Modification Examples

In the above exemplary embodiment, the first support member 88 allows the shaft 86C to be supported on the housing 82 at a predetermined position, but this is not the only possible example. For example, the shaft 86C may be directly supported on the housing 82 as long as the shaft 86C is supported on the housing 82 in a predetermined position. In addition, both of the attachment hole 92A of the first support member 88 and the front end portion of the shaft 86C in the depth direction have a shape of the letter “D”, but may have another shape. For example, the attachment hole 92A and the front end portion of the shaft 86C may have a circular shape, a polygonal shape, or another attachable shape.

In the above exemplary embodiment, the end portion 90B is integrated with the first support member 88, but this is not the only possible structure. For example, the end portion 90B may be separate from the first support member 88. The protrusion 90D is integrated with the third support member 288, but this is not the only possible structure. For example, the protrusion 90D may be separate from the third support member 288. The position may be changed by turning over, instead of rotating.

The image forming portion 12 may form monochrome images through an electrophotographic system, instead of color images.

In the exemplary embodiment, the housing 82 includes the body 82A, the cover 82B, and the side cover 82C, but this is not the only possible example. For example, the housing 82 may have a unit integrated by bonding or welding. Alternatively, the housing 82 may be divisible into two or four or more pieces.

In the above exemplary embodiment, the transporting members are disposed obliquely below the development member, but this is not the only possible example. For example, the transporting members may be disposed on the side of the development member in the width direction.

With the discharge method according to the above exemplary embodiment, the subject that removes the development device 80 from the apparatus body 10a and the subject that changes the position of the development member 86 to the release position may be the same or different.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A discharge method for discharging a developer containing toner from a housing of a development device, the development device including:
the housing that accommodates the developer;
a transporting member that transports the developer in the housing; and
a development member that includes a receiving pole and a release pole, that receives the developer from the transporting member at the receiving pole with a magnetic force and develops a latent image on a photoconductor with the developer, and that releases a surplus developer into the housing at the release pole,
the discharge method comprising:
   changing, while the development device is removed from an image forming apparatus body, a position of the development member with respect to the housing to a release position to direct the release pole toward an outside of the housing; and
   changing a position of the housing to direct the release pole downward while the development member is in the release position, and driving the transporting member to discharge the developer from the housing.
(((2)))

The discharge method according to (((1))),
wherein the development device includes a support member that allows the development member to be supported on the housing, and
wherein a position of the development member is changed to the release position by replacing the support member with another support member that allows the development member to be supported on the housing while the release pole is directed toward an outside of the housing.
(((3)))

The discharge method according to (((1))),
wherein the development device includes a switching member that is switchable between a first position in which a position of the development member is retained while the release pole is directed toward an inside of the housing, and a second position in which the position of the development member is retained while the release pole is directed toward an outside of the housing, and
wherein the position of the development member is changed to the release position by switching the position of the switching member with respect to the housing from the first position to the second position.
(((4)))

The discharge method according to (((3))),
wherein the developer is discharged from the housing in a state where the switching member is switched to the second position and a protuberance of the switching member extends further outward than an outer edge of the development member from the release pole.
(((5)))

A development device, comprising:
a housing that accommodates a developer containing toner;
a transporting member that is disposed in the housing, and that transports the developer;
a development member that includes a receiving pole and a release pole, the receiving pole receiving, with a magnetic force, the developer transported thereto by the transporting member, the release pole releasing the developer received by the receiving pole, the development member being disposed in the housing, and the development member developing a latent image on a photoconductor with the developer received by the receiving pole; and
a switching member that is attachable to the development member and that is switched between a first position in which a position of the development member is retained while the release pole is directed toward an inside of the housing and a second position in which the position of the development member is retained while the release pole is directed toward an outside of the housing.
(((6)))

The development device according to (((5))),
wherein the switching member includes a protuberance that extends further outward than an outer edge of the development member from the release pole while the switching member is switched to the second position.
(((7)))

An image forming apparatus, comprising:
an image forming apparatus body;
a photoconductor that is accommodated in the image forming apparatus body;
the development device according to (((6))) that is attached to the image forming apparatus body, that develops a latent image on the photoconductor, and that is, when attached to the image forming apparatus body while the switching member is switched to the second position, changed into a state of being unattachable to the image forming apparatus body as a result of the protuberance coming into contact with the image forming apparatus body with an attachment operation; and
a transfer device that transfers the latent image to a medium.
(((8)))

An image forming apparatus, comprising:
a photoconductor;
the development device according to (((5))) or (((6))) that develops a latent image on the photoconductor; and
a transfer device that transfers the latent image to a medium.

What is claimed is:

1. A discharge method for discharging a developer containing toner from a housing of a development device, the development device including:
the housing that accommodates the developer;
a transporting member that transports the developer in the housing; and
a development member that includes a receiving pole and a release pole, that receives the developer from the transporting member at the receiving pole with a magnetic force and develops a latent image on a photoconductor with the developer, and that releases a surplus developer into the housing at the release pole,
the discharge method comprising:
changing, while the development device is removed from an image forming apparatus body, a position of the development member with respect to the housing to a release position to direct the release pole toward an outside of the housing; and
changing a position of the housing to direct the release pole downward while the development member is in the release position, and driving the transporting member to discharge the developer from the housing.

2. The discharge method according to claim 1,
wherein the development device includes a support member that allows the development member to be supported on the housing, and
wherein a position of the development member is changed to the release position by replacing the support member with another support member that allows the development member to be supported on the housing while the release pole is directed toward an outside of the housing.

3. The discharge method according to claim 1,
wherein the development device includes a switching member that is switchable between a first position in which a position of the development member is retained while the release pole is directed toward an inside of the housing, and a second position in which the position of the development member is retained while the release pole is directed toward an outside of the housing, and
wherein the position of the development member is changed to the release position by switching the position of the switching member with respect to the housing from the first position to the second position.

4. The discharge method according to claim 3,
wherein the developer is discharged from the housing in a state where the switching member is switched to the second position and a protuberance of the switching member extends further outward than an outer edge of the development member from the release pole.

5. A development device, comprising:
a housing that accommodates a developer containing toner;
a transporting member that is disposed in the housing, and that transports the developer;
a development member that includes a receiving pole and a release pole, the receiving pole receiving, with a magnetic force, the developer transported thereto by the transporting member, the release pole releasing the developer received by the receiving pole, the development member being disposed in the housing, and the development member developing a latent image on a photoconductor with the developer received by the receiving pole; and
a switching member that is attachable to the development member and that is switched between a first position in which a position of the development member is retained while the release pole is directed toward an inside of the housing and a second position in which the position of the development member is retained while the release pole is directed toward an outside of the housing.

6. The development device according to claim 5,
wherein the switching member includes a protuberance that extends further outward than an outer edge of the development member from the release pole while the switching member is switched to the second position.

7. An image forming apparatus, comprising:
an image forming apparatus body;
a photoconductor that is accommodated in the image forming apparatus body;
the development device according to claim 6 that is attached to the image forming apparatus body, that develops a latent image on the photoconductor, and that is, when attached to the image forming apparatus body while the switching member is switched to the second position, changed into a state of being unattachable to the image forming apparatus body as a result of the protuberance coming into contact with the image forming apparatus body with an attachment operation; and
a transfer device that transfers the latent image to a medium.

8. An image forming apparatus, comprising:
a photoconductor;
the development device according to claim 5 that develops a latent image on the photoconductor; and
a transfer device that transfers the latent image to a medium.

9. An image forming apparatus, comprising:
a photoconductor;
the development device according to claim 6 that develops a latent image on the photoconductor; and
a transfer device that transfers the latent image to a medium.

10. A development device, comprising:
housing means for accommodating a developer containing toner;
transporting means for transporting the developer, the transporting means being disposed in the housing means;
development means including a receiving pole and a release pole, the receiving pole receiving, with a magnetic force, the developer transported thereto by the transporting means, the release pole releasing the developer received by the receiving pole, the development means being disposed in the housing means, and the development means developing a latent image on a photoconductor with the developer received by the receiving pole; and
switching means for being attachable to the development means and being switched between a first position in which a position of the development means is retained while the release pole is directed toward an inside of the housing means and a second position in which the position of the development means is retained while the release pole is directed toward an outside of the housing means.
